(19) United States
(12) Patent Application Publication
(10) Pub. No.: US 2025/0038430 A1
(43) Pub. Date: Jan. 30, 2025

(54) Inline Wire Tap Quick Connector

(71) Applicant: PureEdge Lighting LLC, Chicago, IL (US)

(72) Inventors: Gregory L. Kay, Chicago, IL (US); Samuel Welu, Chicago, IL (US)

(21) Appl. No.: 18/360,452

(22) Filed: Jul. 27, 2023

(51) Int. Cl. H01R 4/2408; H01R 13/512; H01R 13/58; H01R 43/01

(52) U.S. Cl. CPC H01R 4/2408; H01R 13/512; H01R 13/5804; H01R 43/01

(57) ABSTRACT

An electrical wire-tapping assembly having a first housing component, attaching to second housing component to retain a primary wire within a wire-receiving channel where an insulation-piercing member secured within the first housing component and extending into the wire-receiving channel pierces the primary wire insulation to create a splice with a wire lead connected by one end passing into the base of the first housing component to the insulation-piercing member. The assembly is configured such that attachment of the second housing component to the first housing component forces the primary wire (i.e., the wire to-be-tapped) positioned within the wire-receiving channel onto the insulation-piercing member to create a splice connection of the wire lead to the wire to-be-tapped.

### TECHNICAL FIELD OF THE INVENTION

The present disclosure relates to electrical wire-tapping connectors. More specifically, the disclosure relates to a solderless device and method for tapping electrical wires.

### BACKGROUND OF THE INVENTION

It is occasionally necessary to tap into an existing electrical wire (primary) to run a “branch” wire to, for example, a light fixture or similar electrical component. Typically, the insulation of the primary wire must be scored and stripped to expose the metal wire within. Then, the end of the branch wire is twisted about the exposed metal wire to create a connection. Soldering the connection was often necessary to prevent it from being pulled apart. Finally, the connection must be covered—e.g., with electrical tape or a snap connector—to insulate and protect the connection.

This process could be tedious and requires several tools. Not a problem for an electrician or a Handyman, but for the “do-it-yourself” novice it is an adventure wrought with potential hazards.

Prior art connectors and line-splicing gadgets have since been created to assist both professional and novice alike. However, most of these devices provide a flimsy connection, while others still require tools and know-how.

Until the invention of the present application, these and other problems in the prior art went either unnoticed or unsolved by those skilled in the art. The present invention provides an inline wire-tap which works without the need for any tools without sacrificing connection integrity, safety, or simplicity.

### SUMMARY OF THE INVENTION

There is disclosed herein an improved wire-tap assembly which avoids the disadvantages of prior devices while affording additional structural and operating advantages.

Generally speaking, the electrical wire-tapping assembly comprises a first housing component having a base and a wire-receiving channel configured to retain a wire-to-be-tapped therein, an insulation-piercing member secured within the base of the first housing component and extending into the wire-receiving channel, a wire lead connected by one end passing into the base of the first housing component to the insulation-piercing member, and a second housing component for engaging the first housing component and securing a wire to-be-tapped within the wire-receiving channel. The assembly is configured such that attachment of the second housing component to the first housing component forces the wire to-be-tapped positioned within the wire-receiving channel onto the insulation-piercing member to create a splice connection of the wire lead to the wire to-be-tapped.

In a more specific embodiment of the assembly, the first housing component comprises a bolt component having a hexagon-shaped head portion, a threaded portion, and a wire-receiving channel, while the second housing component is a nut component having an internal threaded portion corresponding to the threaded portion of the bolt component. Further, the assembly includes the insulation-piercing member secured within the wire-receiving channel of the bolt component and a wire lead passing into the bolt component and connected by one end to the insulation-piercing member.

In specific embodiments, the electrical wire-tapping assembly further comprises a cap component configured to attach to the head of the bolt component to protect the wire lead. The cap component may be configured to be screwed, snap-fitted, or friction fitted onto the bolt component.

Preferably, the wire-receiving channel bisects the threaded portion of the bolt component. Further, the assembly comprises a transverse channel within the head of the bolt component, wherein the transverse channel is perpendicular to the wire-receiving channel.

A method for creating an electrical wire splice connection to a continuous primary wire is also a featured invention. A preferred method comprises providing a wire-tap assembly as described above, positioning the primary wire within the wire-receiving channel, engaging the threaded portion of the nut component with the treaded portion of the bolt component, turning the nut component to force the primary wire through the wire-receiving channel of the bolt component onto the insulation-piercing member, and continuing to turn the nut component until it abuts the head portion of the bolt component thereby causing the insulation-piercing member to contact metal wire to complete the splice connection.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is an exploded view of an embodiment of the disclosed wire-tap assembly, including a primary wire;

FIG. 2 is a perspective view of the embodiment of FIG. 1 illustrating positioning of the assembly of FIG. 1 for connection to the primary wire;

FIG. 3 is a perspective view of the embodiment of FIG. 1 illustrating a final assembly step; and

FIG. 4 is a perspective view of the assembly of FIG. 1 connected to a primary wire.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

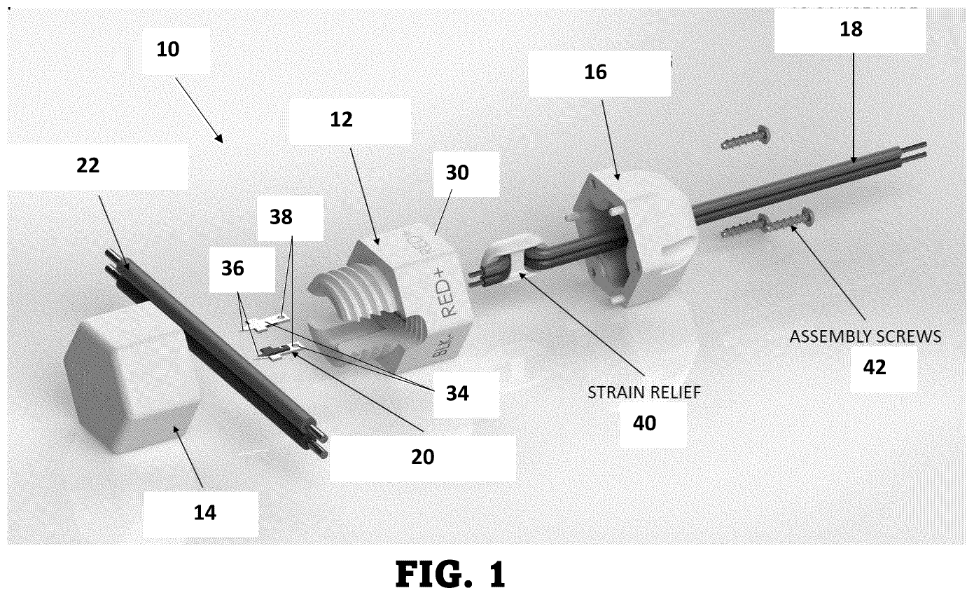

Referring to FIGS. 1-4, there is illustrated at least one embodiment of an electrical wire-tap assembly, generally designated by the numeral 10. The particular illustrated assembly 10 is for an electrical wire, such as for powering lighting, ceiling fans, outlets, and the like. However, while all the embodiments illustrated are directed to tapping an electrical wire, it should be understood that the principles of the invention can be more broadly applied to include speaker wire, video wire, and the like.

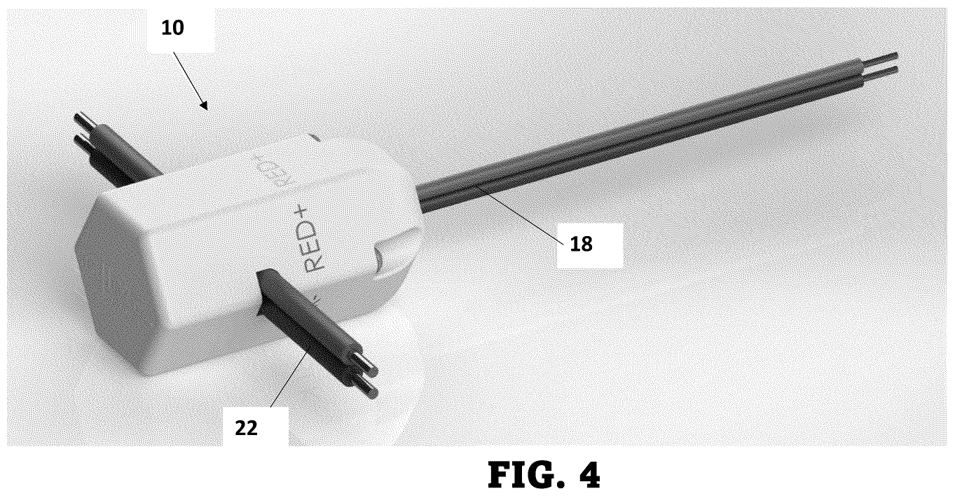

As can be seen in FIG. 1, the assembly 10 comprises a bolt (or first) component 12, a nut (or second) component 14, a cap (or third) component 16, a lead (or branch) wire 18, and an insulation piercing member 20. This assembly 10 connects the lead wire 18 to a primary electrical wire 22 to create a branch for bringing electricity to an electric device, such as a light (not shown). When assembled (FIG. 4), the bolt component 12 and nut component 14 encase a section of the primary electrical wire 22 where a splice is made. The cap component 16 conceals and protects the connection of the end of the lead wire 18 with the insulation piercing member 20.

The bolt component 12 includes a wire-receiving channel 24 that bisects a threaded portion 26 of the bolt component 12. The wire-receiving channel 24 extends just beyond a shoulder 28 of a head portion 30 of the bolt component 12 to create a transverse channel 32, as will be explained further below. Within the head portion 30 of the bolt component 12 and extending into the transverse channel 32 is positioned the insulation piercing member 20. Preferably, the insulation piercing member 20 is comprised of two metal contacts 34 having pointed tips 36. Opposite the pointed tips 36, the metal contacts 34 have a connection site 38 for attaching to the lead wire 18. The lead wire 18 passes into the head portion 30 of the bolt component 12 to attach to the metal contacts 34. The metal contacts 34 should be spaced sufficiently with insulative material in-between to prevent contact with one another. A wire strain relief member 40 may be used to help protect the connection between the lead wire 18 and the insulation piercing member 20 by reducing strain proximate the connection point.

As illustrated, the head 30 of the bolt component 12 and the nut component 14 are both hexagonal for gripping purposes, though other shapes are possible. The inner surface of the nut component 14 comprises threads corresponding to the threaded portion 26 of the bolt component 12. One end of the nut component 14 is closed to further protect and conceal the wire-tap connection. The three body components (i.e., bolt 12, nut 14, and cap 16) are preferably made of a strong, insulative material (e.g., thermoplastic polyurethane). The cap component 16 is preferably attached via screws 42, but it may be configured to be screwed or snap-fitted to the bolt component head 30.

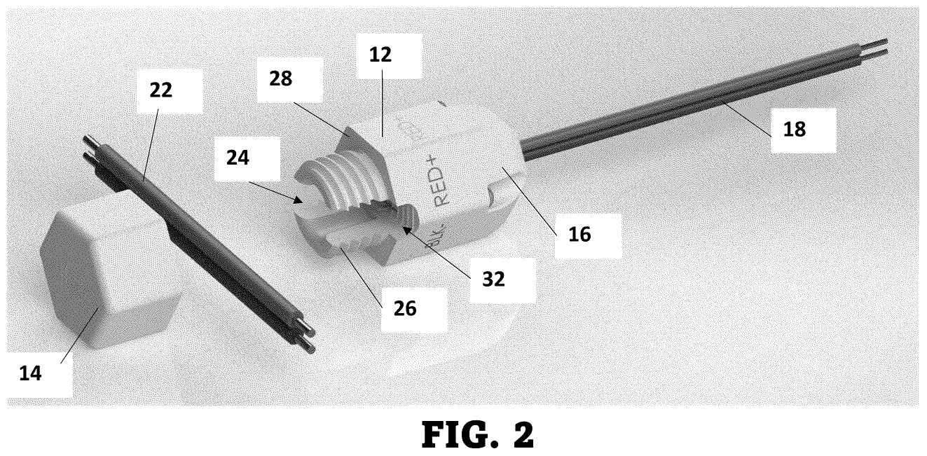

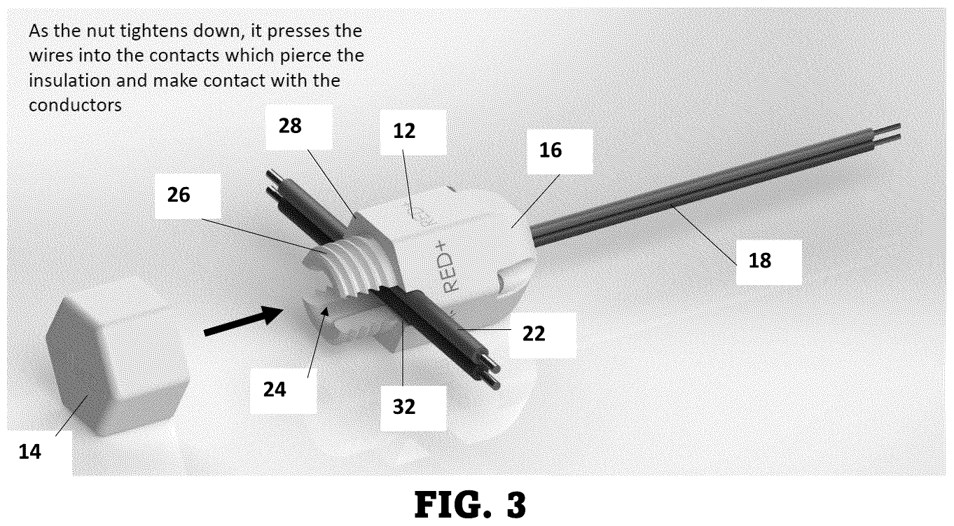

To use the disclosed wire-tap assembly 10, a suitable section of a primary wire 22 is first selected to be tapped and the assembly 10 is positioned accordingly (FIG. 2). If the lead wire 18 is not already connected to the insulation piercing member 20, then it should be done in a suitable manner, as is understood by those of skill in the art. The cap component 16 may or may not be attached as well. Then, the primary wire 22 is positioned within the wire-receiving channel 24 of the bolt component 12 and the nut component 14 is positioned to engage the threaded portion 26 of the bolt component 12 (FIG. 3). The nut component 14 is then carefully threaded onto the bolt component 12. As the nut component 14 moves it pushes the primary wire 22 toward the insulation piercing member 20. Eventually, a side of the primary wire 22 will be forced into the transverse channel 32 where it will contact the pointed tips 36 of the metal contacts 34. Continued movement of the nut component 14 will further force the primary wire 22 into the transverse channel 32 and the pointed tips 36 will then pierce the insulation of the primary wire 22 and make contact with the electric wire therein. The nut component 14 will be stopped at the shoulder 28 of the head component 30, at which point the primary wire 22 will be completely positioned within the transverse channel 32 (FIG. 4). The transverse channel 32 is configured to retain the primary wire 22 in cooperation with the nut component 14 without placing undue stress on the wire which may damage the insulation.

Once the nut component 14 is properly seated on the bolt component 12, the cap component 16 can be secured to the head portion 30 of the bolt component 12. The lead wire 18 can be tested to be sure a splice of the primary wire 22 occurred. The lead wire 18 can then be connected to the electric appliance or device for operation.

The assembly 10 can also be removed by unscrewing the nut component 14 and gently lifting the primary wire 22 from the wire-receiving channel 24 of the bolt component 12. The pierced insulation may be repaired, as necessary, using tape, liquid polymer, or by other suitable means known to those skilled in the art.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. An electrical wire-tapping assembly comprising:
a bolt component having a head, a threaded portion, and a wire-receiving channel;
a nut component having an internal threaded portion corresponding to the threaded portion of the bolt component;
an insulation-piercing member secured within the wire-receiving channel of the bolt component; and
a wire lead passing into the bolt component and connected by one end to the insulation-piercing member;
wherein the nut component forces a wire to-be-tapped positioned within the wire-receiving channel of the bolt component onto the insulation-piercing member as the nut component is threaded onto the bolt component.

2. The electrical wire-tapping assembly of claim 1, further comprising a cap component configured to attach to the head of the bolt component to protect the wire lead.

3. The electrical wire-tapping assembly of claim 2, wherein the cap component friction fits onto the bolt component.

4. The electrical wire-tapping assembly of claim 3, wherein the wire-receiving channel bisects the threaded portion of the bolt component.

5. The electrical wire-tapping assembly of claim 1, further comprising a transverse channel within the head of the bolt component, wherein the transverse channel is perpendicular to the wire-receiving channel.

6. The electrical wire-tapping assembly of claim 4, further comprising a transverse channel within the head of the bolt component, wherein the transverse channel is perpendicular to the wire-receiving channel.

7. The electrical wire-tapping assembly of claim 6, wherein the transverse channel intersects the wire-receiving channel.

8. The electrical wire-tapping assembly of claim 1, wherein the head of the bolt component and the nut component each have a hexagonal shape.

9. The electrical wire-tapping assembly of claim 1, wherein the insulation-piercing member comprises two metal contacts, each having a pointed tip for piercing insulation on the wire to-be-tapped.

10. An electrical wire-tapping assembly comprising:
a first housing component having a base and a wire-receiving channel configured to retain a wire-to-be-tapped therein;
an insulation-piercing member secured within the base of the first housing component and extending into the wire-receiving channel;
a wire lead connected by one end passing into the base of the first housing component to the insulation-piercing member;
a second housing component for engaging the first housing component and securing a wire to-be-tapped within the wire-receiving channel;
wherein attachment of the second housing component to the first housing component forces the wire to-be-tapped positioned within the wire-receiving channel onto the insulation-piercing member to create a splice connection of the wire lead to the wire to-be-tapped.

11. The electrical wire-tapping assembly of claim 10, further comprising a third housing component configured to attach to the head of the first housing component to protect the wire lead.

12. The electrical wire-tapping assembly of claim 10, wherein the second housing component comprises threads which engage threads on the first housing component.

13. The electrical wire-tapping assembly of claim 10, wherein the second housing component friction fits onto the first housing component.

14. The electrical wire-tapping assembly of claim 13, wherein the first and second housing components have a hexagonal shape.

15. The electrical wire-tapping assembly of claim 10, wherein the insulation-piercing member comprises two metal contacts, each having a pointed end for piercing insulation on the wire to-be-tapped.

16. The electrical wire-tapping assembly of claim 10, further comprising a transverse channel within the base of the first component, wherein the transverse channel is perpendicular to the wire-receiving channel.

17. The electrical wire-tapping assembly of claim 16, wherein the transverse channel intersects the wire-receiving channel.

18. A method for creating an electrical wire splice connection to a continuous primary wire, the method comprising:
providing a wire-tap assembly comprising:
a bolt component having a head, a threaded portion, and a wire-receiving channel;
a nut component having an internal threaded portion corresponding to the threaded portion of the bolt component;
an insulation-piercing member secured within the wire-receiving channel of the bolt component; and
a wire lead passing into the bolt component and connected by one end to the insulation-piercing member;
positioning the primary wire within the wire-receiving channel;
engaging the threaded portion of the nut component with the treaded portion of the bolt component;
turning the nut component to force the primary wire through the wire-receiving channel of the bolt component onto the insulation-piercing member;
continuing to turn the nut component until it abuts the head portion of the bolt component thereby causing the insulation-piercing member to contact metal wire to complete the splice connection.

19. The method of claim 16, further comprising attaching a cap component to the head portion of the bolt component to protect the wire lead.

20. The method of claim 16, wherein the assembly further comprises a transverse channel within the head of the bolt component, the transverse channel being perpendicular to the wire-receiving channel, and the method further comprising forcing the primary wire into the transverse channel.

21. The method of claim 20, wherein the transverse channel intersects the wire-receiving channel.
